(19) United States
(12) Patent Application Publication
(10) Pub. No.: US 2009/0055459 A1
(43) Pub. Date: Feb. 26, 2009

(54) FREQUENCY-DOMAIN EQUALIZER

(76) Inventor: Michael Speth, Krefeld (DE)

Correspondence Address: ESCHWEILER & ASSOCIATES LLC, 629 EUCLID AVENUE, SUITE 1000, NATIONAL CITY BUILDING, CLEVELAND, OH, 44114, US

(21) Appl. No.: 11/844,880

(22) Filed: Aug. 24, 2007

(51) Int. Cl. G06F 17/14

(52) U.S. Cl. 708/404

(57) ABSTRACT

A digital signal processing structure includes a processing unit configured to perform a fast Fourier transformation of length N on signal samples of word length WL, wherein the processing unit is configured to vary during operation the values of N and WL_in in a reverse fashion with respect to one another. A frequency-domain equalizer includes a length N, wherein the value of N is variable during operation.

### FIELD OF THE INVENTION

The present invention relates to a digital signal processing structure, a frequency-domain equalizer, a receiver of a communication system, a method for performing a fast Fourier transformation, and a frequency-domain equalizing method.

### BACKGROUND OF THE INVENTION

In wireless communication systems transmitted symbols are subject to strong disturbance effects in a multi-path channel. The disturbance effects are essentially caused by interference phenomena like inter-symbol interference (ISI). In a receiver unit of the communication system appropriate measures have to be taken in order to reverse or to reduce the influence of the disturbance effects on the received data symbols.

In modern receiver systems like e.g. UMTS receiver systems, for example, linear equalizer systems are employed which are able to eliminate the inter-symbol interference to a great extent. In these equalizer systems an equalization coefficient vector is calculated for a channel profile by means of suitable optimization algorithms. It can be assumed that the channel can be represented by a channel impulse response function having a discrete number of singular values at specific delay times. In general, for channels having a large number of response values, in a receiver system an equalizer should be used which also has a great number of filter taps and filter coefficients.

### BRIEF DESCRIPTION OF THE SEVERAL VIEWS OF THE DRAWINGS

Aspects of the invention are made more evident in the following detailed description of embodiments when read in conjunction with the attached drawing figures., wherein:

FIG. 1 shows a schematic representation of an embodiment of a digital signal processing structure;

FIG. 2 shows a schematic representation of a further embodiment of a digital signal processing structure;

FIG. 3 shows a flow diagram of an embodiment of a method for performing a fast Fourier transformation;

FIG. 4 shows a schematic representation of a further embodiment of a digital signal processing structure,;

FIG. 5 shows a schematic representation of a further embodiment of a digital signal processing structure;

FIG. 6 shows a schematic representation of an embodiment of a frequency-domain equalizer;

FIG. 7 shows a flow diagram of an embodiment of a frequency-domain equalizing method; and

FIG. 8 shows a schematic representation of a further embodiment of a frequency-domain equalizer.

In the following, the term “fast Fourier transformation” will be used several times throughout the description and the claims. This term normally is related to a transformation from the time-domain to the frequency-domain. It should be understood, however, that in this application the terms “fast Fourier transformation” and “inverse fast Fourier transformation” are interchangeable with each other so that in each case the term “fast Fourier transformation” is used also the term “inverse fast Fourier transformation” could be used instead to cover also a transformation from the frequency-domain to the time-domain.

### DETAILED DESCRIPTION OF THE INVENTION

The aspects and embodiments of the invention are now described with reference to the drawings, wherein like reference numerals are generally utilized to refer to like elements throughout. In the following description, for purposes of explanation, numerous specific details are set forth in order to provide a thorough understanding of one or more aspects of embodiments of the invention. It may be evident, however, to one skilled in the art that one or more aspects of the embodiments of the invention may be practiced with a lesser degree of the specific details. In other instances, known structures and devices are shown in block diagram form in order to facilitate describing one or more aspects of the embodiments of the invention. The following description is therefore not to be taken in a limiting sense, and the scope of the invention is defined by the appended claims.

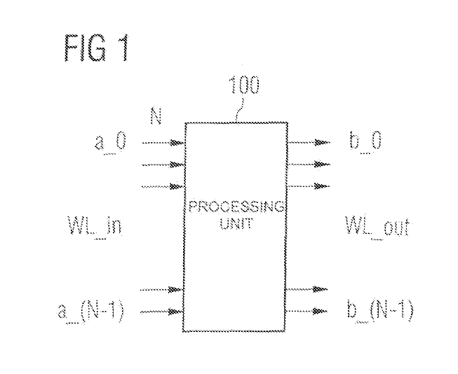

Referring to FIG. 1, there is shown a schematic block representation of an embodiment of a digital signal processing structure. The digital signal processing structure comprises a processing unit 100 to perform a fast Fourier transformation of length N which means that N time samples a_0, . . . , a_(N-1) are input in parallel to the processing unit and N frequency samples b_0, . . . , b_(N-1) are output in parallel out of the processing unit 100. The time samples a_0, . . . , a_(N-1) are, in one embodiment, obtained as consecutive time samples from a receiver front end and input into a serial-to-parallel converter (not shown) which can be coupled to the processing unit 100. The time samples a_0, . . . , a_(N-1) are input into a serial input of the serial-to-parallel converter and they are output at N output terminals of the serial-to-parallel converter, the N output terminals being coupled to the N input terminals of the processing unit 100.

The processing unit 100 comprises N parallel output terminals to output the N frequency samples b_0, . . . , b_(N-1) in a parallel manner.

In one embodiment the time samples a_0, . . . , a_(N-1) each comprise a word length WL_in. The value of the word length WL_in of the time samples a_0, . . . , a_(N-1) as input into the processing unit 100 can be different from the value of the word length of the time samples as obtained directly from the receiver front end, as will be explained further below in more detail. The frequency samples b_0, . . . , b_(N-1) each also comprise a word length WL_out, respectively. In one embodiment the word length WL_in of the time samples can be identical to the word length WL_out of the frequency samples. However, it is also possible that WL_in and WL_out have different values.

One feature of the digital signal processing structure as shown in FIG. 1 is that during operation of the digital signal processing structure 100 the values of one or both of N and WL_in can be varied. In particular, they can be varied in a manner reverse to each other. That means, if the length N of the first Fourier transformation is increased, the word length WL_in of the time samples a_0, . . . , a_(N-1) can be decreased, and if the length N of the first Fourier transformation is decreased, the word length WL_in of the time samples a_0, . . . , a_(N-1) can be increased. It is also possible that, in one embodiment, the length N of the first Fourier transformation is increased or decreased, and the word length WL_in of the time samples is not changed.

The variation of N and/or WL_in, in particular the variation of these quantities reverse to each other, can be performed during operation of the processing unit 100. More specifically, input signals are received at the receiver front end having a particular word length. For reasons outlined further below it can be decided that the length L of the fast Fourier transformation and the word length WL_in should be changed. The word length of the received signals is then converted to a new word length so that the received signals are transformed into signals having the new word length. From these word length converted signals a consecutive sequence of time samples a_0, . . . , a_(N-1) is taken out and input into the serial-to-parallel converter and input in parallel into the N input terminals of the processing unit 100.

The processing unit 100 comprises an internal structure that allows to vary the values N and WL_in reverse to each other. That means, if the length N of the fast Fourier transformation should be reduced, a correspondingly reduced number of time samples a_0, . . . , a_(N-1) is input into the processing unit 100 into a corresponding number of input terminals. On the other hand, the word length of each of the time samples a_0, . . . , a_(N-1) is increased so that the processing unit 100 will perform a fast Fourier transformation on a reduced number of time samples, each of the time samples having an increased word length.

Referring to FIG. 2, there is shown a schematic block representation of a further embodiment of a digital signal processing structure. The digital signal processing structure comprises a processing unit 200 as shown in FIG. 2, which is a specific embodiment of the digital signal processing structure as shown in FIG. 1. The digital signal processing structure as shown in FIG. 2 comprises a processing unit 200 which is built up on the base of a butterfly structure. The processing unit 200 is arranged to perform a fast Fourier transformation of length N. More specifically, the processing unit 200 is comprised of processor elements which are themselves known in the prior art as butterfly elements 210. The number of the butterfly elements 210 of the processing unit 200 is N/2×1d(N), where N is the length of the fast Fourier transformation. In each one of the butterfly elements 210 one of the input data path is multiplied with one of a plurality of so-called twiddle factors, respectively, and then the product is added to the second input data path. A fast Fourier transformation consists of an iterative interconnection of these butterfly elements 210. It will be explained in a further specific embodiment below how the length N of the fast Fourier transformation and the word length WL_in can be varied reverse to each other in such a butterfly structure.

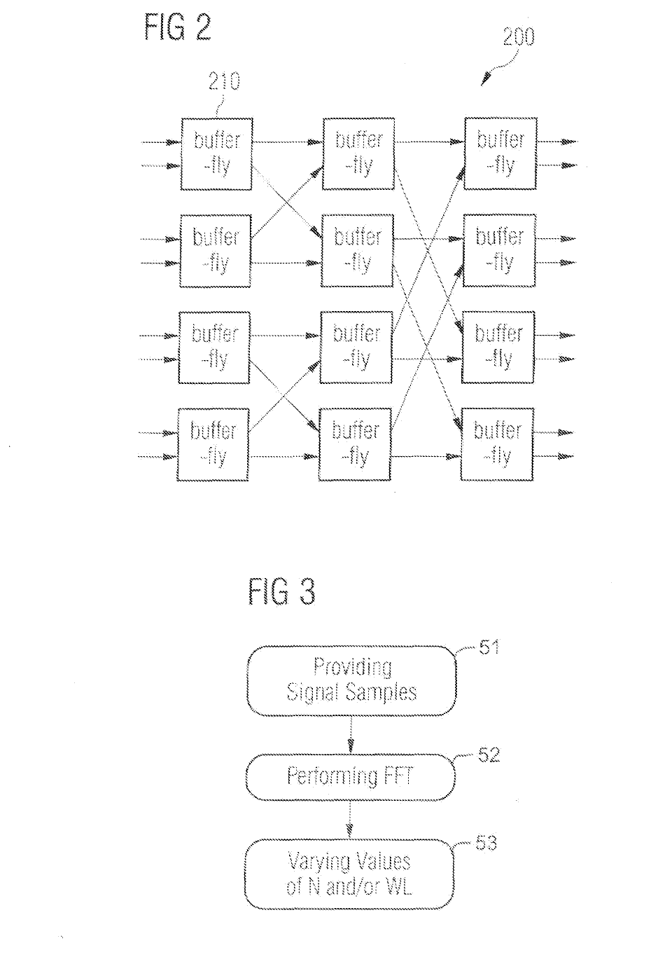

Referring to FIG. 3, there is shown a flow diagram of an embodiment of a method for performing a fast Fourier transformation. Although the method is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the devices and systems illustrated and described herein as well as in association with other structures not illustrated. Signal samples are provided each having a word length WL, respectively at s1. A fast Fourier transformation of length N is performed on the signal samples at s2, and the values of N and/or WL_in are varied at s3.

In one embodiment the varying of the values of N and WL_in can be performed during operation, which means that a fast Fourier transformation can be performed with first values of N and WL_in on first signal samples and immediately thereafter a fast Fourier transformation can be performed with second values of N and WL_in on the second signal samples. Moreover, the varying of the values of N and WL_in can be performed upon and depending on the occurrence of certain pre-determined conditions. Examples of these pre-determined conditions will be outlined further below. As soon as the pre-determined conditions have occurred, the values of N and WL_in can be changed without any interruption of the process. The amounts of changes of the values of N and WL_in can also be dependent on the pre-determined conditions in one embodiment.

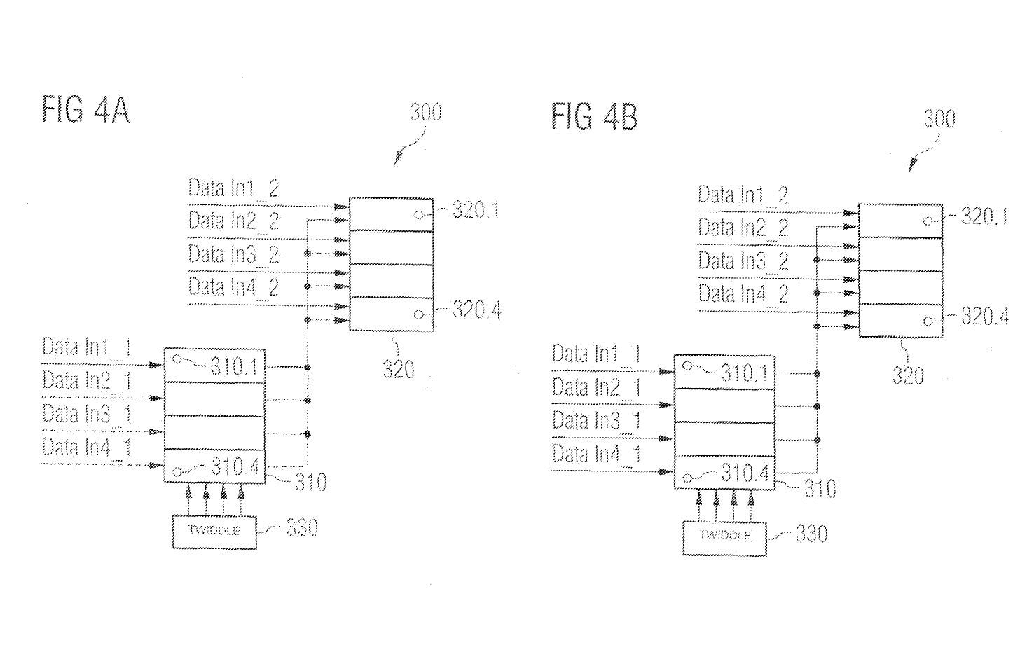

Referring to FIG. 4, there is shown a schematic block representation of a further embodiment of a digital signal processing structure. The digital signal processing structure is comprised of a processing unit 300. The processing unit 300 is re-configurable and it is shown in two different configurations in this embodiment. The processing unit 300 can be one of the butterfly elements 210 as shown in FIG. 2. The processing unit 300 is comprised of a multiplying unit 310 and an adding unit 320. The multiplying unit 310 is comprised of a plurality of n multiplying elements 310.1, . . . , 310.n and the adding unit 320 is comprised of a plurality of n adding elements 320.1, . . . , 320.n. In the embodiment as depicted in FIG. 4 the value of n is equal to 4. The multiplying unit 310 is connected to a twiddle factor unit 330. The twiddle factor unit 330 supplies twiddle factors to the multiplying elements 310.1, . . . , 310.n.

In portion A of FIG. 4, there is shown a first configuration of the processing unit 300 in which two time samples Data In1_1 and Data In1_2, indicated by thick arrows, are supplied to the processing unit 300, wherein a first time sample Data In1_1 is supplied to the multiplying unit 310, and a second time sample Data In1_2 is supplied to the adding unit 320. In the first configuration of the processing unit 300, the first time sample Data In1_1 is input into the first multiplier element 310.1, and the second time sample Data In1_2 is input into the first adding element 320.1. The first time sample Data In1_1 is multiplied with one of the twiddle factors and the result of the multiplication, i.e. the product is output by the first multiplying element 310.1 and input into the first adding element 320.1 where it is added to the second time sample Data In1_2. In one embodiment the multiplying unit 310 is configured as a variable multiplying unit. That means, the hardware elements of the multiplying unit 310, essentially comprising half-adders as will be outlined further below, can be used to multiply few time samples of great word length or many time samples of small word length. For example, as shown in the configuration of portion A the first multiplying element 310.1 makes use of the hardware elements of the further multiplying elements 310.2 to 310.4 in order to multiply the first time sample Data In1_1 with the respective twiddle factor. In the same way, the adding unit 320 is configured as a bit-variable adding unit. That means the adding element 320.1 makes use of the hardware elements, in particular the half-adders, of the further adding elements 320.2 to 320.4 in order to perform the adding of the second time sample Data In1_2 to the product as output by the multiplying unit 310. As indicated by thin dashed arrows, the multiplying elements 310.2 to 310.4 are configured to virtually receive time samples Data In2_1, Data In3_1 and Data In4_1 which are, however, actually not present in the configuration of portion A of FIG. 4.

In the configuration as shown in portion B of FIG. 4, the configuration is changed in that the length N of the fast Fourier transformation is increased with respect to the configuration of portion A, and at the same time the word length WL_in of the time samples is decreased. It can be seen that now four time samples Data In1_1, Data In2_1, Data In3_1 and Data In4_1 are supplied to the multiplying unit 310, wherein a first time sample Data In1_1 is input into the first multiplying element 310.1, a second time sample Data In2_1 is input into a second multiplying element 310.2, a third time sample Data In3_1 is input into a third multiplying element 310.3, and a fourth time sample Data In4_1 is input into a fourth multiplying element 310.4. In the multiplying elements 310.1 to 310.4 the first to fourth time samples are multiplied with respective twiddle factors obtained from the twiddle factor unit 330. The respective products of the multiplications are output by the multiplying unit 310 and input into the adding unit 320. The product which is output by the first multiplying element 310.1 is input into the first adding element 320.1. At the same time a fifth time sample Data In1_2 is input into the first adding element 320.1. The product of the second multiplying element 310.2 is input into the second adding element 320.2 and at the same time a sixth time sample Data In2_2 is input into the second element 320.2. The product of the third multiplying element 310.3 is input into the third adding element 320.3 and at the same time a seventh time sample Data In3_2 is input into the third adding element 320.3. The product of the fourth multiplying element 310.4 is input into the fourth adding element 320.4 and at the same time an eighth time sample Data In4_2 is input into the fourth adding element 320.4.

In one embodiment the microscopic architecture of each multiplying unit or multiplying element comprises a matrix of half-adders. In order to implement a multiplication of two signals like, for example, two time samples having word length WB1, one needs in general WB1×WB1 half-adders. If the word length WB1 is halved to WB2=WB1/2, a respective multiplier would need only WB1/4 half-adders. Accordingly one could realize multiplications for up to four butterfly blocks with the available number of half-adders. The above example implies that the values of N and WL_in are varied such that N is proportional to 1/(WL_in)². In a similar way, the adding elements can be re-configured to a plurality of adding elements of less word length. In this case the number of additional adding elements scales linearly with the word length so that for fully employing the scaling of the multiplier unit, additional adding elements of less word length should be provided.

The hardware structures as depicted in FIGS. 3 and 4 can be used variably as a butterfly structure with a word length WB1 or as four butterfly structures with word length WB2. In a similar way the storage capacity of the original fast Fourier transformation can be effectively utilized in that the word length can be reduced accordingly. The architecture as shown in FIG. 4 represents only one of a plurality of possible implementations for realizing a functionality of a digital signal processing structure having variable length N of fast Fourier transformation and word length WL_in. For example, it is also possible in an alternative embodiment to only double the number of butterflies and to scale the word length by one of two different factors or to use half-adders for realizing the additional adding elements.

One advantage of the digital signal processing structure as depicted in the above embodiments lies in the fact that increasing the length of the fast Fourier transformation can be realized without additional hardware resources, but rather by re-configuring the digital signal processing structure as provided. Besides that, a significantly reduced power consumption can be obtained as compared with a conventional implementation. If the requirements with respect to the quantization are lowered, then the word length of the time samples can be reduced and in exchange the length of the fast Fourier transformation can be increased.

The hardware structure as shown in FIG. 4 is related primarily to a radix-2 implementation as only two paths are added with each other. Also when using a small word length, the architecture would have to be regarded as a radix-2 implementation wherein the processing of a plurality of butterfly elements would be implemented in parallel. In general, however, one could also implement a radix-4 architecture, wherein when using a small word length, radix-4 is implemented, and when using a great word length, radix-2 would be implemented. In any case, the input terminals of the butterfly elements are supplied with the adequate data which can be accomplished with a suitable addressing unit such as that shown in the next figure.

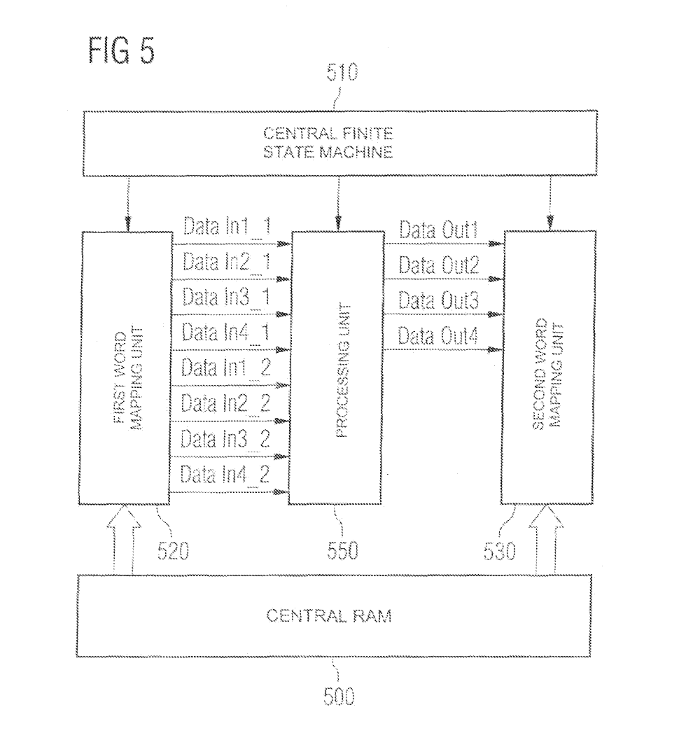

Referring to FIG. 5, there is shown an addressing structure for generating addresses for supplying the input terminals of the butterfly elements of the suitable data elements. The addressing structure comprises a central RAM 500 for storing data elements like time samples or products output by the multiplier elements wherein the data elements are to be supplied to the butterfly elements. The addressing structure further comprises a central FSM 510 (Finite State Machine) for generating addresses. The FSM 510 is used for generating addresses so that data elements will be correctly addressed to input terminals of the butterfly elements. For this purpose the FSM 510 copies the respective data elements from the central RAM 500 in a first word mapping unit 520 which is used to multiplex data words on the input terminals of each butterfly element. In connection with the concept of a scaleable word length it is also possible that in one data word of length WL1 a plurality of data elements of word length WL2 are combined for allowing the saving of hardware resources also with respect to the dimension of the RAM 500. The processing unit 550 can be implemented as the processing units 100, 200 or 300, as depicted in one of FIGS. 1, 2 or 4, respectively. In particular, the processing unit 550 can comprise a butterfly structure as was outlined in detail in the previous embodiment of FIG. 4. The output terminals of the processing unit 550 are connected to a second word mapping unit 530 which is connected to the RAM 500. In the second word mapping unit 530 the data samples generated in the processing unit 550 are mapped to RAM words and stored in the RAM 500 at an address which is determined by the FSM 510.

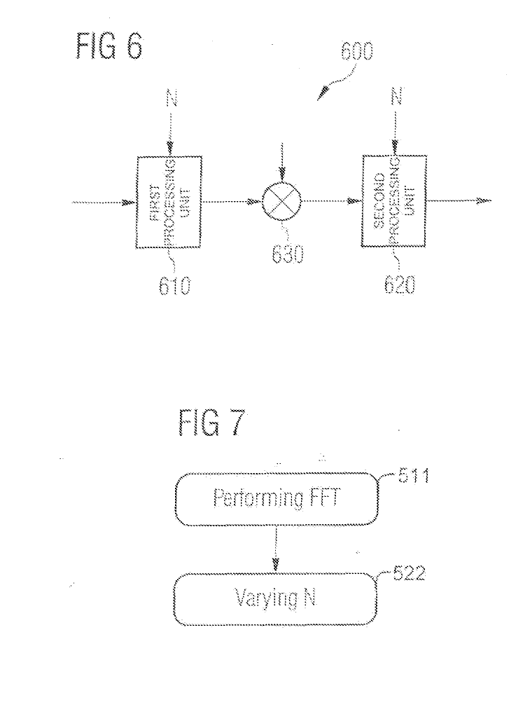

Referring to FIG. 6, there is shown a schematic block representation of an embodiment of a frequency-domain equalizer. The frequency domain equalizer 600 as depicted in FIG. 6 comprises a length N, wherein the value of N is variable during operation of the frequency-domain equalizer 600.

In particular, the frequency-domain equalizer 600 comprises a filter structure wherein the length N is to be understood as the filter size or, in other words, the number of filter coefficients. The frequency-domain equalizer 600 according to the embodiment of FIG. 6 is comprised of a first processing unit 610 to perform a fast Fourier transformation of length N, wherein the value of N is variable during operation of the frequency-domain equalizer 600. The first processing unit 610 can be implemented according to the embodiments as outlined above in FIGS. 1, 2 or 4 in connection with the respective description text above. In particular, the processing unit 610 can be configurable so that the values of the length N of the fast Fourier transformation and the word length WL_in of time samples to be processed are variable in a reverse manner. The frequency-domain equalizer 600 according to the embodiment of FIG. 6 further comprises a second processing unit 620 to perform an inverse fast Fourier transformation of length N, wherein the value of N is variable during operation of the frequency-domain equalizer 600. The frequency-domain equalizer 600 further comprises a multiplier 630 having a first input coupled to an output of the first processing unit 610, a second input coupled to a coefficient calculation block (not shown), and an output coupled to the second processing unit 620. The first processing unit 610 has N output terminals for outputting the N frequency samples of the Fourier transformation, the N output terminals being connected to the multiplier 630. In the multiplier 630 the N frequency samples are multiplied with N coefficients obtained from the coefficient calculation block. The second processing unit 620 has N input terminals for inputting the N multiplication products as output by the multiplier 630. The second processing unit 620 also has N output terminals for outputting the N time samples as obtained by the inverse fast Fourier transformation.

Referring to FIG. 7, there is shown a flow diagram of an embodiment of a frequency-domain equalizing method. The method comprises performing a fast Fourier transformation of length N on signal samples at s11, and varying the value of N during operation at s22.

In a further embodiment of the frequency-domain equalizing method, the fast Fourier transformation is performed on signal samples of word length WL, and the values of N and WL_in are varied in a reverse manner.

In a further embodiment of the frequency-domain equalizing method the signal samples, in particular the time samples, are generated from an input signal as obtained from a receiver front end, for example. Furthermore, the varying of N or, if appropriate, of N and WL_in in a reverse manner, can be initiated upon and in dependence on certain pre-determined conditions. It can be monitored whether and when the pre-determined conditions occur. For example, the pre-determined conditions can be given as conditions of the input signal as received from the receiver front end. More specifically, in one embodiment the conditions can be related to a signal-to-noise ratio and/or a signal-to-interference ratio of the input signal. For example, if the signal-to-noise ratio is low, the quantization, i.e. the word length of the received signal can be reduced. At the same time, however, the length N of the Fourier transformation can be increased. If, however, the signal-to-noise ratio of the input signal is high, then a high level quantization, i.e. a high word length of the input signal would be adequate so that in this case the length N of the Fourier transformation can be reduced and the word length WL_in can be increased.

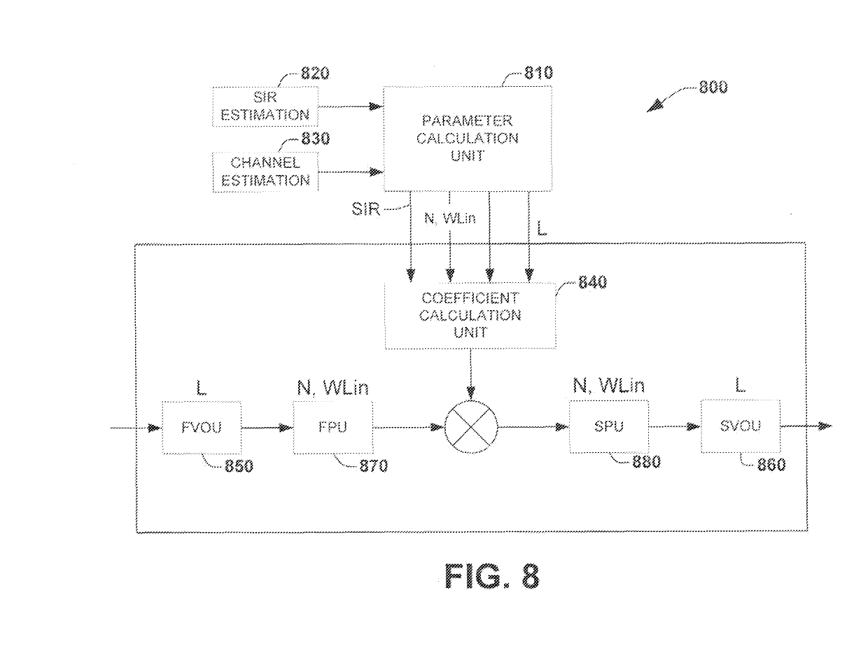

Referring to FIG. 8, there is shown a schematic block representation of a further embodiment of a frequency-domain equalizer which can be part of a receiver system. The frequency-domain equalizer 800 is connected to a parameter calculation unit 810 and the parameter calculation unit 810 is connected to an SIR (signal-to-interference ratio) estimation unit 820 and a channel estimation unit 830. The frequency-domain equalizer 800 is a further embodiment of the frequency-domain equalizer 600 as depicted in the embodiment of FIG. 6. The frequency-domain equalizer 800 of FIG. 8 comprises a first processing unit (FPU) 870, a second processing unit (SPU) 880, a multiplier 890, and a coefficient calculation unit 840. The first processing unit 870 performs a variable first Fourier transformation and delivers N frequency samples to the multiplier 890 in which the N frequency samples are multiplied with N equalization coefficients obtained from the coefficient calculation unit 840. The multiplication products are output by the multiplier 890 and delivered to the second processing unit 880 in which an inverse fast Fourier transformation is performed to output N equalized time samples.

The frequency-domain equalizer 800 also comprises a first variable overlap-save unit (FVOU) 850. An input signal received from a receiver front end is supplied to an input of the first overlap-save unit 850, and an output of the first overlap-save unit 850 is connected to an input of the first processing unit 810. An output of the second processing unit 820 is connected to an input of a second variable overlap-save unit (SVOU) 860, which comprises an output terminal to output the equalized time samples. As it is in principle well-known in the art, the overlap-save procedure cuts the signal up into segments of equal length L with some overlap between them.

In the parameter calculation unit 810 the parameters SIR, WL, N and L are calculated, wherein SIR is the noise and interference power, WL_in is the word length, N is the variable value for the length of the fast Fourier transformation, and L is the variable length of the first and second overlap-save units 850 and 860. These four parameters are calculated on the basis of the inputs as obtained from the SIR estimation unit 820 and the channel estimation unit 830. The variable values of N and WL_in as calculated in the parameter calculation unit 810 are also delivered to the first and second processing unit 810 and 820 so that they are re-configured in accordance with the variation of the values of N and WL_in.

The hardware structure as depicted in FIG. 8 can be part of a digital receiver like, for example, a UMTS receiver unit. In this case, the channel estimation unit 830 can comprise an additional delay profile estimation unit.

One advantage of the frequency domain equalizer of FIG. 8 lies in the fact that without increasing the number or dimension of hardware resources the equalizer can be used for scenarios with short impulse response lengths of the channel as well as for scenarios with long impulse response lengths of the channel. Moreover, by scaling the word length, the power consumption of the equalizer can be optimized in case of long channel response functions. In channel scenarios having short channel response functions and low SIR, in particular in cases of multi-user interference, the word length of the equalizer can be adaptively reduced and in this way the power consumption can be reduced.

Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A digital signal processing structure, comprising:
a processing unit configured to perform a fast Fourier transformation of length N on signal samples of word length WL_in, wherein
the processing unit is configured to vary the values of one or more of N and WL_in during operation thereof.

2. The digital signal processing structure of claim 1, wherein the processing unit is configured to vary the values of N and WL_in in inverse fashion with respect to each other.

3. The digital signal processing structure of claim 1, wherein the processing unit comprises a butterfly structure.

4. The digital signal processing structure of claim 1, wherein the processing unit comprises a plurality of multiplying units configured to perform multiplying operations on the signal samples.

5. The digital signal processing structure of claim 4, wherein each multiplying unit is configured so that the number of simultaneous multiplying operations and the value of WL_in are variable in a reverse manner with respect to one another.

6. The digital signal processing structure of claim 1, wherein the processing unit comprises a plurality of adding units configured to perform adding operations on the signal samples.

7. The digital signal processing structure of claim 6, wherein each adding unit is configurable so that the number of simultaneous adding operations and the value of WL_in are variable in a reverse manner with respect to one another.

8. A frequency-domain equalizer, comprising a processing unit configured to perform a fast Fourier transformation of length N, wherein N is variable during operation thereof.

9. The frequency-domain equalizer of claim 8, wherein:
the processing unit is adapted to perform the fast Fourier transformation on signal samples of word length WL_in, and wherein
the processing unit is configured to vary the values of N and WL_in in a reverse manner with respect to one another.

10. The frequency-domain equalizer of claim 8, wherein the processing unit further comprises:
a first processing unit configured to perform a fast Fourier transformation of length N, wherein the value of N is variable; and
a second processing unit configured to perform an inverse fast Fourier transformation of length N, wherein the value of N is variable.

11. The frequency-domain equalizer of claim 10, further comprising:
a multiplier having a first input coupled to an output of the first processing unit, a second input coupled to a coefficient calculation block, and an output coupled to the second processing unit.

12. The frequency-domain equalizer of claim 10, further comprising:
a first overlap-save unit comprising an output coupled to an input of the first processing unit; and
a second overlap-save unit comprising an input coupled to an output of the second processing unit.

13. A receiver for a communication system, comprising:
a frequency-domain equalizer of length N, wherein N is variable during operation;
wherein the equalizer is adapted to process signal samples of word length WL_in; and
wherein the values of N and WL_in are variable in a reverse manner with respect to one another.

14. The receiver of claim 13, wherein the frequency-domain equalizer comprises a processing unit to perform a fast Fourier transformation of length N, and wherein N is variable during operation thereof.

15. The receiver of claim 13, further comprising a signal-to-noise or signal-to-interference ratio estimation unit coupled to the equalizer.

16. The receiver of claim 15, further comprising:
a parameter calculation unit coupled to the signal-to-noise estimation unit, wherein the parameter calculation unit is configured to calculate the value of N based on the estimated signal-to-noise or signal-to-interference ratio.

17. The receiver of claim 13, further comprising a channel estimation unit coupled to the equalizer.

18. A method for performing a fast Fourier transformation, comprising:
providing signal samples, each having a word length WL_in, respectively;
performing a fast Fourier transformation of length N; and
varying one or more of the values of N and WL_in during the transformation.

19. The method of claim 18, further comprising varying the values of N and WL_in in a reverse manner with respect to one another.

20. The method of claim 18, further comprising performing multiplying operations on the signal samples, wherein the number of simultaneous multiplying operations and the value of WL_in are variable in a reverse manner with respect to one another.

21. The method of claim 18, further comprising:
performing adding operations on the signal samples, wherein the number of simultaneous adding operations and the value of WL_in are variable in a reverse manner with respect to one another.

22. A frequency-domain equalizing method, comprising:
performing a fast Fourier transformation of length N on signal samples; and
varying the value of N during the transformation.

23. The method of claim 22, wherein the transformation further comprises:
performing the fast Fourier transformation on signal samples of word length WL_in; and
varying the values of N and WL_in in a reverse manner with respect to one another.

24. The method of claim 22, wherein the transformation further comprises:
performing a fast Fourier transformation of length N on N time samples, thereby obtaining N frequency samples;
multiplying the frequency samples with N coefficients, thereby obtaining N multiplied frequency samples; and
performing an inverse fast Fourier transformation on the multiplied frequency samples.

25. The method of claim 22, further comprising:
estimating a signal-to-noise and/or signal-to-interference ratio of a received signal; and
calculating the value of N based on the estimated signal-to-noise and/or signal-to-interference ratio.
